(19) United States
(12) Patent Application Publication
(10) Pub. No.: US 2026/0310039 A1
(43) Pub. Date: Oct. 8, 2026

(54) ARRAY SUBSTRATE AND DISPLAY DEVICE

(71) Applicant: Sharp Kabushiki Kaisha, Osaka (JP)

(72) Inventors: Hideki KITAGAWA, Sakai City (JP); Yoshihito HARA, Sakai City (JP); Masaki MAEDA, Sakai City (JP); Jun NISHIMURA, Sakai City (JP); Yoshiharu HIRATA, Sakai City (JP); Kengo HARA, Sakai City (JP)

(21) Appl. No.: 19/636,017

(22) Filed: Apr. 1, 2026

(30) Foreign Application Priority Data
Apr. 7, 2025 (JP) 2025-063038

(51) Int. Cl. G02F 1/1685; G02F 1/167; G02F 1/16766

(52) U.S. Cl. CPC G02F 1/1685; G02F 1/167; G02F 1/16766

(57) ABSTRACT

An array substrate comprises a first electrode including a first conductive film; a first insulation film disposed on the first conductive film; a second electrode including a second conductive film on the first insulation film and partially overlapping the first electrode; a second insulation film disposed on the second conductive film; a third electrode including a third conductive film on the second insulation film and partially overlapping the second electrode that does not overlap the first electrode; and a fourth electrode including the first conductive film, but overlapping the second electrode that does not overlap the first electrode, wherein a first contact hole that connects the first electrode and the second electrode is provided at the first insulation film, and a second contact hole that connects the second electrode and the third electrode is provided at the second insulation film, that does not overlap the first contact hole.

### CROSS-REFERENCE TO RELATED APPLICATION

The present application claims priority from Japanese Application JP2025-063038, the content of which is hereby incorporated by reference into this application.

### FIELD

The present specification discloses techniques related to an array substrate and a display device in both of which connection failures are less likely to occur.

### BACKGROUND

The array substrate described in WO-A1-2013/073619 has been known as an example of an array substrate included in a liquid crystal display device. The semiconductor device that is an array substrate described in WO-A1-2013/073619 includes: a thin film transistor; an interlayer insulation layer including a first insulation layer; a first transparent conductive layer provided on the interlayer insulation layer and having a first opening; a dielectric layer covering a side face of the first transparent conductive layer on the first opening side; and a second transparent conductive layer overlapping at least a part of the first transparent conductive layer via the dielectric layer, wherein the dielectric layer has a second opening, the first insulation layer has a third opening, the interlayer insulation layer and the dielectric layer have a first contact hole, the first contact hole has a sidewall including a side face of the second opening and a side face of the third opening, at least a part of the side face of the third opening matches the side face of the second opening, the second transparent conductive layer is in contact with a drain electrode inside the first contact hole to form a contact section, and at least a part of the contact section overlaps a gate line layer when viewed normal to the substrate.

### SUMMARY

In the semiconductor device described in WO-A1-2013/073619 mentioned above, the first contact hole runs through a total of three layers: namely, two interlayer insulation layers and a dielectric layer. Therefore, a film break is likely to occur in the part of the second transparent conductive layer that is disposed inside the first contact hole. A possible approach to prevent such a film break is to, for example, employ a structure in which an intermediate electrode is provided by using, for example, a metal layer and a transparent electrode layer both disposed between the drain electrode and the second transparent conductive layer and is connected to the drain electrode and the second transparent conductive layer. However, when there is only a limited space for mounting the intermediate electrode, there are cases where the two respective openings in the first insulation layer and the second insulation layer and the opening in the dielectric layer must overlap each other. In such a circumstance, the opening in the dielectric layer needs to reside inside the openings in the first insulation layer and the second insulation layer, and for this reason, it is difficult to form the opening in the dielectric layer in a normal manner, which may disadvantageously result in, for example, the opening in the dielectric layer having an opening edge with a reverse-tapered cross-sectional shape. In such a case, a connection failure may occur between the intermediate electrode and the second transparent conductive layer.

The techniques described in the present specification have been completed in view of these circumstances and have an object to render connection failures less likely to occur.
(1) An array substrate in accordance with a technique described in the present specification includes: a first electrode including a part of a first conductive film; a first insulation film disposed on an upper layer side of the first conductive film; a second electrode including a part of a second conductive film on an upper layer side of the first insulation film and partially overlapping the first electrode; a second insulation film disposed on an upper layer side of the second conductive film; a third electrode including a part of a third conductive film on an upper layer side of the second insulation film and partially overlapping a part of the second electrode that does not overlap the first electrode; and a fourth electrode including a part of the first conductive film and not overlapping the first electrode, but overlapping a part of the second electrode that does not overlap the first electrode, wherein a first contact hole that connects the first electrode and the second electrode is provided at a location, in the first insulation film, that overlaps both the first electrode and the second electrode, and a second contact hole that connects the second electrode and the third electrode is provided at a location, in the second insulation film, that overlaps both the second electrode and the third electrode, but that does not overlap the first contact hole.
(2) Additionally, the array substrate may be configured, in addition to (1) described above, so as to further include: a semiconductor segment including a part of a semiconductor film on a lower layer side of the first conductive film and connected to the first electrode; and a cover segment including a part of the second conductive film and covering the semiconductor segment, wherein the second conductive film contains a metal material, the cover segment is disposed overlapping a part of the fourth electrode, and a third contact hole that connects the cover segment and the fourth electrode is provided at a location, in the first insulation film, that overlaps both the cover segment and the fourth electrode.
(3) Additionally, the array substrate may be configured, in addition to (2) described above, such that the first electrode extends in a first direction from a location overlapping a part of the semiconductor segment at least to a location overlapping a part of the second electrode, the cover segment extends in a second direction intersecting with the first direction from a location overlapping the semiconductor segment to a location overlapping a part of the fourth electrode, the fourth electrode extends in the first direction from a location overlapping a part of the cover segment at least to a location that is separated by a distance in the second direction from the first electrode, and the second electrode includes: a first extension extending in the second direction from a location overlapping the first electrode away from the first electrode; and a second extension extending in the first direction from the first extension at least to a location that is separated by a distance in the second direction from the cover segment.
(4) Additionally, the array substrate may be configured, in addition to any one of (1) to (3) described above, so as to further include: a semiconductor segment including a part of a semiconductor film on a lower layer side of the first conductive film and connected to the first electrode; a third insulation film disposed on a lower layer side of the semiconductor film; a fifth electrode including a part of a fourth conductive film on a lower layer side of the third insulation film and overlapping the semiconductor segment; and a sixth electrode including a part of the fourth conductive film, wherein the sixth electrode is disposed overlapping a part of the first electrode and further overlapping each of the second electrode, the third electrode, and the fourth electrode, and a fourth contact hole that connects the first electrode and the sixth electrode is provided at a location, in the third insulation film, that overlaps both the first electrode and the sixth electrode.
(5) A display device in accordance with a technique described in the present specification includes: the array substrate of any one of (1) to (4) described above; an opposite substrate disposed opposite the array substrate; and a display layer configured to display an image and disposed so as to be sandwiched between the array substrate and the opposite substrate.
(6) Additionally, the display device may be configured, in addition to (5) described above, so as to further include: a seventh electrode provided on the opposite substrate opposite the third electrode; a first wiring line including a part of the third conductive film and provided on the array substrate opposite a part of the seventh electrode; and a connecting portion disposed so as to be sandwiched between the opposite substrate and the array substrate and connected to the seventh electrode and the first wiring line.
(7) Additionally, the display device may be configured, in addition to (6) described above, such that the third conductive film is a transparent electrode film containing a transparent electrode material.
(8) Additionally, the display device may be configured, in addition to any one of (5) to (7) described above, such that the display layer is an electronic paper layer containing a plurality of microcapsules containing charged particles or a plurality of microcups containing charged particles, and the second electrode and the third electrode include a plurality of second electrodes and a plurality of third electrodes respectively so as to overlap each of the plurality of microcapsules or each of the plurality of microcups.

### Advantageous Effects of the Disclosure

The techniques described in the present specification can render connection failures less likely to occur.

### BRIEF DESCRIPTION OF DRAWINGS

FIG. 1 is a plan view of an electronic paper display device in accordance with Embodiment 1.

FIG. 2 is a cross-sectional view of a cross-sectional structure of a microcapsule layer in the electronic paper display device in accordance with Embodiment 1.

FIG. 3 is a circuit diagram of an electrical configuration of an array substrate in the electronic paper display device in accordance with Embodiment 1.

FIG. 4 is a plan view of a pixel arrangement on the array substrate in accordance with Embodiment 1.

FIG. 5 is a cross-sectional view of the array substrate in accordance with Embodiment 1 taken along line v-v shown in FIG. 4.

FIG. 6 is a cross-sectional view of the array substrate in accordance with Embodiment 1 taken along line vi-vi shown in FIG. 4.

FIG. 7 is a cross-sectional view of the array substrate in accordance with Embodiment 1 taken along line vii-vii shown in FIG. 4.

FIG. 8 is a cross-sectional view of the array substrate in accordance with Embodiment 1 taken along line viii-viii shown in FIG. 4.

FIG. 9 is a cross-sectional view of an X-axis-wise end portion of the electronic paper display device in accordance with Embodiment b 1.

### DESCRIPTION OF EMBODIMENTS

### Embodiment 1

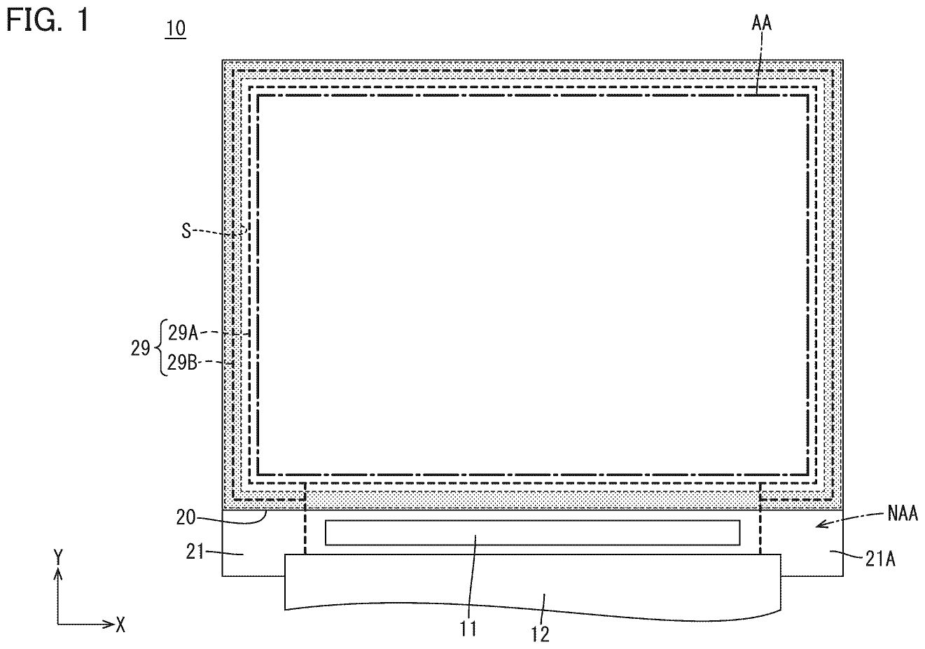

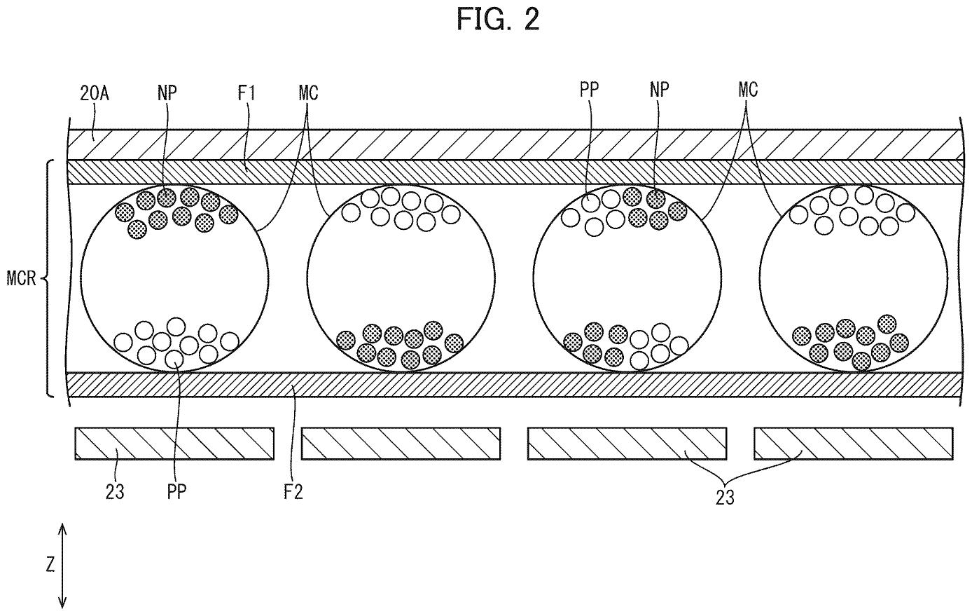

A description is now given of Embodiment 1 with reference to FIGS. 1 to 9. The present embodiment discusses as an example an electronic paper display device (display device; EPD: electronic paper display) 10. Note that an X-axis, a Y-axis, and a Z-axis are shown in a part of each drawing, and each axial direction is drawn to be a direction shown in each drawing. In addition, in FIGS. 2 and 5 to 9, the upper side is the front side, and the lower side is the back side.

The electronic paper display device 10 has a horizontally elongated rectangular shape as shown in FIG. 1. In the present embodiment, the electronic paper display device 10 operates by using microencapsulated electrophoretic technology. The electronic paper display device 10 has, in a central portion of its primary face, a display area AA where images are displayed. Meanwhile, the electronic paper display device 10 has, in a frame-shaped peripheral portion of the primary face surrounding the display area AA, a non-display area NAA where no images are displayed.

Referring to FIG. 1, the electronic paper display device 10 includes: an array substrate 21 that is a back plane; and an opposite substrate 20 attached on the front side opposite the array substrate 21. Both the opposite substrate 20 and the array substrate 21 include, for example, a substantially transparent, synthetic resin substrate (resin substrate). Between the opposite substrate 20 and the array substrate 21, there is interposed a microcapsule layer (display layer) MCR containing microcapsules MC enclosing charged particles as shown in FIG. 2. Note that FIG. 2 omits both substrates 20 and 21. The microcapsule layer MCR includes: a pair of films F1 and F2; and the numerous microcapsules MC sandwiched between the films F1 and F2. The microcapsules MC include at least: positively charged particles PP that are a positively charged white-looking pigment (e.g., titanium oxide particles); and negatively charged particles NP that are a negatively charged black-looking pigment (e.g., carbon black particles). In addition, there is provided an opposite electrode (seventh electrode) 20A on the inner face (the face opposite the array substrate 21) side of the opposite substrate 20. The opposite electrode 20A is made of a transparent electrode material and provided as a common layer so as to extend at least all across the entire display area AA on the inner face of the opposite substrate 20. The opposite electrode 20A is disposed opposite a plurality of pixel electrodes 23 in the array substrate 21 across the microcapsule layer MCR, which will be described later in detail.

Referring to FIG. 1, the opposite substrate 20 has a shorter short-side dimension than does the array substrate 21. The opposite substrate 20 is attached to the array substrate 21 so that one of the two end portions of each substrate in terms of the short-side direction (Y-axis direction) is aligned. Therefore, the other end portion of the array substrate 21 in terms of the short-side direction is an exposed portion 21A that projects sideways from the opposite substrate 20 and hence is exposed. This exposed portion 21A is entirely the non-display area NAA and has, mounted thereto, a flexible substrate 12 and a driver (signal supply section) 11 for supplying various signals. Between the outer peripheral portion of the opposite substrate 20 and the outer peripheral portion of the array substrate 21, there is provided a sealing portion S all along the entire outer peripheral portions. The sealing portion S extends along the periphery of the opposite substrate 20 and the array substrate 21 and has a rectangular frame shape in a plan view. FIG. 1 shows the region where the sealing portion S is provided as a hatched region.

In a portion of the array substrate 21 that is covered by the opposite substrate 20, there is provided a capacitor main line (common main line) 29 shaped like a frame that is slightly larger than the display area AA and also slightly smaller than the opposite substrate 20 as shown in FIG. 1. The capacitor main line 29 includes: a first main line structural component 29A; and a second main line structural component (first wiring line) 29B disposed on the outer circumference side of the first main line structural component 29A, and the first main line structural component 29A and the second main line structural component 29B are connected to each other. The first main line structural component 29A is connected to capacitor branch lines 26 on the array substrate 21, which will be described later in detail. The second main line structural component 29B is disposed overlapping the sealing portion S and connected to the opposite electrode 20A on the opposite substrate 20, which will be described later in detail.

The driver 11 includes an LSI chip containing a drive circuit therein. The driver 11 processes various signals transferred by the flexible substrate 12. The driver 11 is disposed adjacent to a side of the display area AA (lower side in FIG. 1) in terms of the Y-axis direction in the exposed portion 21A of the array substrate 21 and is interposed between the flexible substrate 12 and the display area AA in terms of the Y-axis direction. The driver 11 has a horizontally elongated rectangular shape in a plan view. The driver 11 is capable of supplying various signals to various wiring lines and other members in the array substrate 21. The flexible substrate 12 includes a pattern of many wiring lines on a base member made of an electrically insulating and flexible synthetic resin material (e.g., a polyimide-based resin). The flexible substrate 12 is connected at one of its ends to the exposed portion 21A of the array substrate 21 and at the other end to an external circuit board (e.g., control board) (not shown).

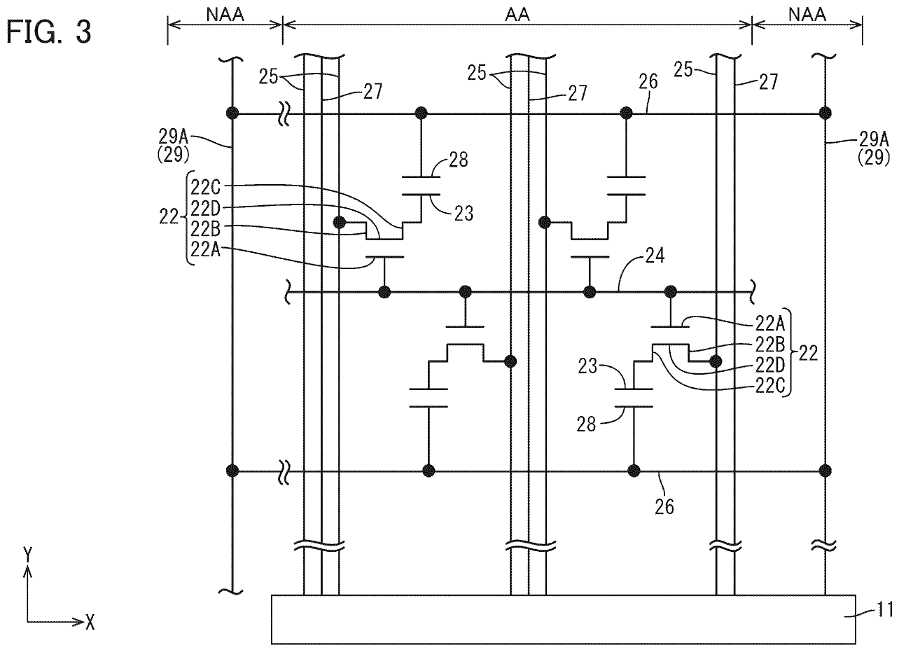

A description is given next of an electrical configuration of the array substrate 21 with reference to FIG. 3. On the inner face side of the display area AA of the array substrate 21, there are provided at least TFTs (thin film transistors, switching elements) 22 and the pixel electrodes 23 as shown in FIG. 3. The TFTs 22 and the pixel electrodes 23 are arranged in rows and columns at intervals in terms of the X-axis direction and the Y-axis direction like in a matrix. Around the TFTs 22 and the pixel electrodes 23, there are provided gate lines (scan lines) 24, source lines (image lines, signal lines) 25, the capacitor branch lines 26, and gate connection lines 27 that intersect orthogonally with (cross) each other. Each TFT 22 includes: a gate electrode (fifth electrode) 22A connected to one of the gate lines 24; a source electrode 22B connected to one of source lines 25; a drain electrode (first electrode) 22C connected to one of the pixel electrodes 23; and a semiconductor segment 22D connected to the source electrode 22B and the drain electrode 22C. Then, the TFT 22 is driven on the basis of a scan signal supplied by the gate line 24 to the gate electrode 22A. Then, an electrical potential related to the image signal supplied by the source line 25 to the source electrode 22B is supplied to the drain electrode 22C via the semiconductor segment 22D. As a result, the pixel electrode 23 is charged to the electrical potential related to the image signal. Note that the scan signal includes a higher electrical potential than the threshold voltage of the TFT 22. In addition, on the inner face side of the display area AA of the array substrate 21, there is provided a capacitor electrode 28 that forms an electrostatic capacitor between the capacitor electrode 28 and the pixel electrode 23. In addition, on the inner face side of the non-display area NAA of the array substrate 21, the aforementioned capacitor main line 29 is provided.

The gate lines 24 and the capacitor branch lines 26 both extend in the X-axis direction (first direction) as shown in FIG. 3. The gate lines 24 and the capacitor branch lines 26 are arranged next to each other alternately and repeatedly at intervals in terms of the Y-axis direction (a second direction intersecting with the first direction). One of the TFTs 22 and one of the pixel electrodes 23 are interposed between one of the gate lines 24 and one of the capacitor branch lines 26 that are adjacent to each other at an interval in terms of the Y-axis direction. The number of the gate lines 24 provided and the number of the capacitor branch lines 26 provided are approximately half the number of those pixel electrodes 23 that are arranged next to each other in the Y-axis direction. The gate line 24 is connected to the gate electrode 22A of the TFT 22 in the display area AA. The gate line 24 is connected to the gate electrode 22A of the TFT 22 connected to one of the pixel electrodes 23 positioned on the upper side (upper side in FIG. 3) of the gate line 24 and also to the gate electrode 22A of the TFT 22 connected to one of the pixel electrodes 23 positioned on the lower side (lower side in FIG. 3) of the gate line 24. In other words, the arrangement is such that one of the gate lines 24 supplies a scan signal to the gate electrode 22A of each TFT 22 connected to each pixel electrode 23 located in the two rows that are adjacent in terms of the Y-axis direction.

Referring to FIG. 3, each capacitor branch line 26 is disposed straddling the display area AA and the non-display area NAA and is connected to one of the capacitor electrodes 28 in the display area AA. The capacitor branch line 26 is connected, at the end portion of its segment that is drawn out to the non-display area NAA, to a Y-axis-wise extension of the first main line structural component 29A of the capacitor main line 29. The first main line structural component 29A is connected to all the capacitor branch lines 26 that are arranged next to each other at intervals in terms of the Y-axis direction. The capacitor branch lines 26 are configured to be fed with a prescribed reference potential signal (common potential signal) from the first main line structural component 29A. Therefore, the capacitor electrodes 28 are configured to be fed with the reference potential signal from the first main line structural component 29A through the capacitor branch lines 26. Note that the capacitor main line 29 is configured to be connected to either the driver 11 or the flexible substrate 12 to be fed with the reference potential signal from either the driver 11 or an external circuit board. The capacitor electrode 28, which is fed with the reference potential signal from one of the capacitor branch lines 26, is capable of maintaining the electrical potential of the charged pixel electrode 23 by forming an electrostatic capacitance between the capacitor electrode 28 and the pixel electrode 23. The capacitor branch line 26 is connected at both of its end portions in terms of the X-axis direction to the first main line structural component 29A.

The source lines 25 and the gate connection lines 27 both extend in the Y-axis direction as shown in FIG. 3. The source lines 25 are provided in pairs between those pixel electrodes 23 that are adjacent to each other in terms of the X-axis direction. In addition, the source line 25 is provided also in a location that is separated by a distance from one of the pixel electrodes 23 that is positioned on an X-axis-wise end of the display area AA toward the non-display area NAA. Therefore, the number of the source lines 25 provided is approximately twice the number of those pixel electrodes 23 that are arranged next to each other in the X-axis direction. The source line 25 is disposed straddling the display area AA and the non-display area NAA and is connected to the driver 11 at the end portion of its segment that is drawn out to the non-display area NAA. The source line 25 is configured to be fed with an image signal from the driver 11.

Referring to FIG. 3, one of the gate connection lines 27 is provided between those pixel electrodes 23 that are adjacent to each other in terms of the X-axis direction. The gate connection line 27 provided between those pixel electrodes 23 that are adjacent to each other in terms of the X-axis direction is interposed between the two source lines 25 that are provided between those pixel electrodes 23 that are adjacent to each other in terms of the X-axis direction. In addition, the gate connection line 27 is provided also in a location that is separated by a distance from one of the source lines 25 that is positioned on an X-axis-wise end of the display area AA toward the non-display area NAA. The number of the gate connection lines 27 provided is approximately equal to the number of those pixel electrodes 23 that are arranged next to each other in the X-axis direction and is at least greater than or equal to the number of the gate lines 24 provided. The gate connection lines 27 are disposed straddling the display area AA and the non-display area NAA and are connected to the gate lines 24 in the display area AA. One or more of the gate connection lines 27 is/are connected to each one of all the gate lines 24 provided in the display area AA. The gate connection line 27 is connected to the driver 11 at the end portion of its segment that is drawn out to the non-display area NAA. The gate connection line 27 is configured to fed with a scan signal from the driver 11. Therefore, the gate line 24 is configured to be fed with a scan signal from the driver 11 through the gate connection line 27.

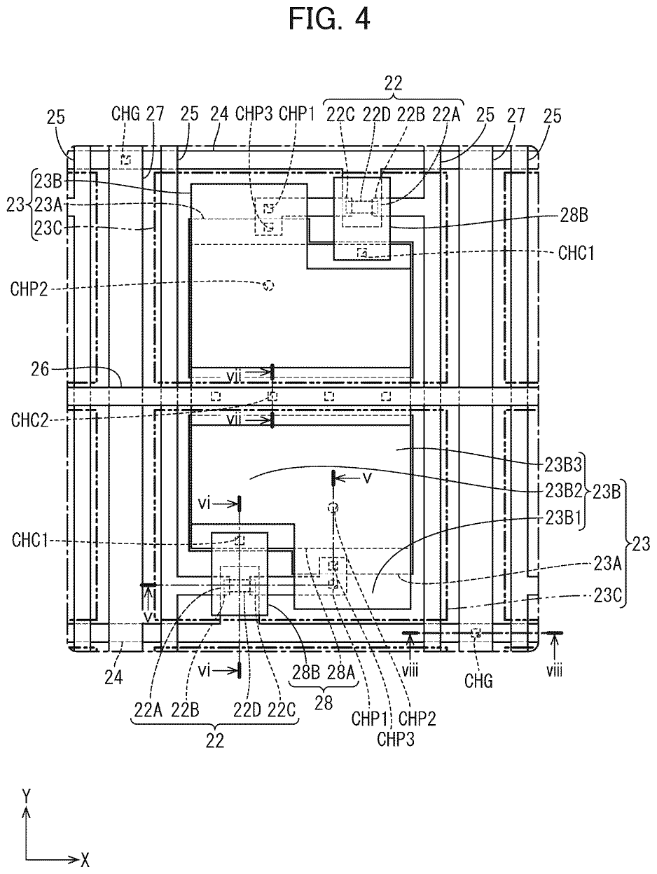

A description is now given of a planar structure of the array substrate 21 with reference to FIG. 4. Referring to FIG. 4, the gate electrode 22A, included in the TFT 22 in the display area AA of the array substrate 21, is provided extending in the Y-axis direction from a portion of the gate line 24 that is located near an intersection of the gate line 24 and the source line 25. The source electrode 22B, included in the TFT 22, is provided extending in the X-axis direction from a portion of the source line 25 that is located near an intersection of the source line 25 and the gate line 24. The source electrode 22B is disposed at an end of the TFT 22 in terms of the X-axis direction. The source electrode 22B overlaps a part of the gate electrode 22A and is connected to the semiconductor segment 22D.

Referring to FIG. 4, the drain electrode 22C, included in the TFT 22, is disposed at a location that is separated by a distance in the X-axis direction from the source electrode 22B, in other words, disposed at the other end of the TFT 22 in terms of the X-axis direction. The drain electrode 22C extends in the X-axis direction, and its end portion on the source electrode 22B side is disposed to overlap a part of the gate electrode 22A and connected to the semiconductor segment 22D. The end portion of the drain electrode 22C that is located opposite the source electrode 22B side is connected to the pixel electrode 23. In other words, the drain electrode 22C extends in the X-axis direction from the location where it overlaps a part of the semiconductor segment 22D all the way to the location where it overlaps a part of the pixel electrode 23 (second electrode segment 23B). The semiconductor segment 22D, included in the TFT 22, has a horizontally elongated shape extending in the X-axis direction. The semiconductor segment 22D is disposed overlapping the gate electrode 22A in a plan view. The semiconductor segment 22D is connected, at one of its end portions in terms of the X-axis direction, to the source electrode 22B and connected, at the other end portion in terms of the X-axis direction, to the drain electrode 22C. Note that the TFTs 22 include those TFTs 22 that reside adjacently on the upper side of the gate lines 24 in FIG. 4 and those TFTs 22 that reside adjacently on the lower side of the gate lines 24 in FIG. 4 and also note that these TFTs 22 have structures that are obtained by vertically and horizontally inverting the structure shown in FIG. 4.

Referring to FIG. 4, each pixel electrode 23, disposed in the display area AA of the array substrate 21, is provided in a region surrounded by one of the gate lines 24, one of the capacitor branch lines 26, and two of the source lines 25. The pixel electrode 23 has a generally vertically elongated rectangular shape. The pixel electrode 23 exhibits an excellent light reflectivity and is disposed opposite the opposite electrode 20A included in the opposite substrate 20 (see FIG. 1) across the microcapsule layer MCR. As the pixel electrode 23 is charged, the charged particles NP and PP move inside the microcapsules MC in accordance with the polarity and electrical potential of the pixel electrode 23. The light that strikes the microcapsule layer MCR from outside the electronic paper display device 10 through the opposite substrate 20 is either transmitted or absorbed by the charged particles NP and PP located inside the microcapsules MC toward the opposite substrate 20 side with respect to the Z-axis direction. Hence, the reflection of light is controlled for each pixel electrode 23 so as to display a prescribed image in the display area AA. Note that a color display becomes possible when the opposite substrate 20 is provided with a color filter.

Referring to FIG. 4, the capacitor electrode 28 is disposed extending in the Y-axis direction and overlapping the plurality of pixel electrodes 23 that are arranged next to each other in the Y-axis direction in a plan view. The capacitor electrode 28 is disposed extending across at least two pixel electrodes 23 in terms of the Y-axis direction and overlapping these two pixel electrodes 23. More specifically, the capacitor electrode 28 includes: a capacitor electrode main body (fourth electrode) 28A overlapping the two pixel electrodes 23 interposed between the two gate lines 24 that are adjacent to each other at a distance in terms of the Y-axis direction; and a cover segment 28B overlapping a part of the capacitor electrode main body 28A and covering a part of the TFT 22. The capacitor electrode main body 28A extends in the Y-axis direction straddling the two pixel electrodes 23 and traverses the capacitor branch line 26 extending in the X-axis direction. The capacitor electrode main body 28A is connected at its portion that overlaps the capacitor branch line 26 (detailed later). A plurality of capacitor electrode main bodies 28A are arranged next to each other at prescribed intervals in terms of the Y-axis direction. The number of those capacitor electrode main bodies 28A that are arranged next to each other is approximately half the number of those pixel electrodes 23 that are arranged next to each other in the Y-axis direction.

Referring to FIG. 4, the cover segment 28B extends in the Y-axis direction from the location where it overlaps a part of the capacitor electrode main body 28A (first capacitor contact hole CHC1 (detailed later)) toward the TFT 22 side and covers at least the semiconductor segment 22D in the TFT 22. The cover segment 28B is connected at its portion that overlaps the capacitor electrode main body 28A (detailed later). The cover segment 28B has a light-blocking property and is capable of rendering light less likely to directly enter the semiconductor segment 22D. Hence, the properties of the TFT 22 are rendered less likely to decay. A plurality of capacitor electrodes 28, each structured in this manner, are arranged next to each other at intervals in terms of the X-axis direction.

Referring to FIG. 4, the capacitor branch line 26 is disposed to extend substantially straightly in the X-axis direction in the display area AA and to traverse all those capacitor electrodes 28 that are arranged next to each other in the X-axis direction. The capacitor branch line 26 is connected to each of all those capacitor electrodes 28 that are arranged next to each other in the X-axis direction. The capacitor branch line 26 is connected to a Y-axis-wise extension of the first main line structural component 29A of the capacitor main line 29 in the non-display area NAA (see FIG. 3).

Referring to FIG. 4, both the source line 25 and the gate connection line 27 extend substantially straightly in the Y-axis direction in the display area AA and crosses all those gate lines 24 and those capacitor branch lines 26 that are arranged next to each other in the Y-axis direction. The source line 25 is disposed at a location that is separated by a prescribed distance from the pixel electrode 23 and the capacitor electrode 28 in terms of the X-axis direction. The gate connection line 27 is disposed at a location that is separated by a distance from the source line 25 opposite the pixel electrode 23 and the capacitor electrode 28 in terms of the X-axis direction. The gate connection line 27 is wider than the source line 25.

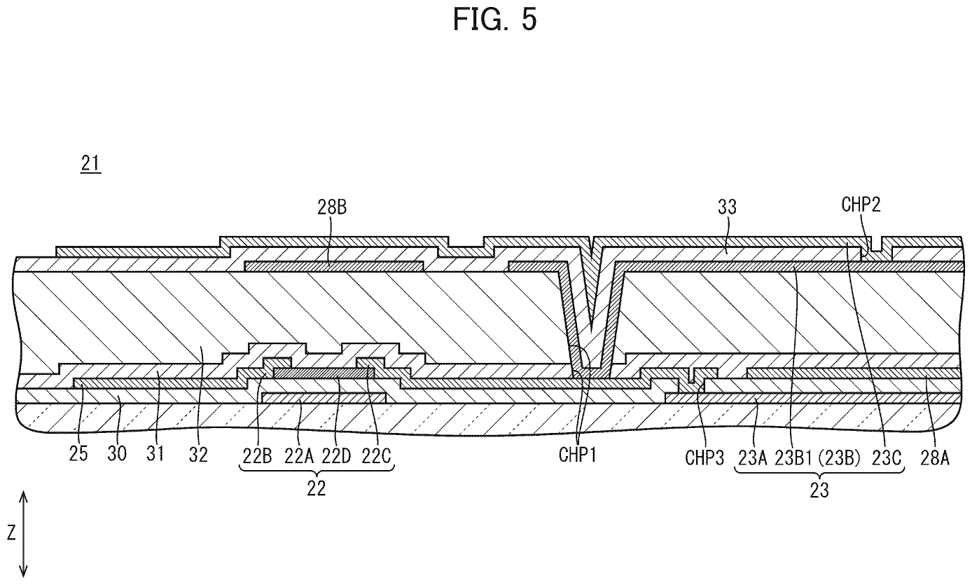

A description is now given of various films formed in a stack on the inner face side of the array substrate 21 with reference to FIG. 5. FIG. 5 is a cross-sectional view of the array substrate 21 near the TFT 22. Referring to FIG. 5, the array substrate 21 includes a stack of at least a first metal film (fourth conductive film), a gate insulation film (third insulation film) 30, a semiconductor film, a second metal film (a first conductive film), a first interlayer insulation film (first insulation film) 31, a planarization film (first insulation film) 32, a third metal film (second conductive film), a second interlayer insulation film (second insulation film) 33, and a transparent electrode film (third conductive film), all of which are provided in this order when viewed from a lower layer side (from the resin substrate side).

Each of the first metal film, the second metal film, and the third metal film is either a monolayer film of a single type of metal material selected from, for example, copper, titanium, aluminum, molybdenum, and tungsten or, for example, a film stack or an alloy of different types of metal materials and hence has conductive and light-blocking properties. The first metal film constitutes, for example, a part of the pixel electrode 23, a part of the gate line 24, the gate electrode 22A of the TFT 22, a part of the gate connection lines 27, and a part of the capacitor main line 29. The second metal film constitutes, for example, a part of the gate line 24, the source line 25, the source electrode 22B and the drain electrode 22C of the TFT 22, a part of the gate connection line 27, a part of the capacitor electrode 28, and a part of the capacitor main line 29. The third metal film constitutes, for example, a part of the pixel electrode 23, the capacitor branch line 26, and a part of the capacitor electrode 28.

The semiconductor film is made of an oxide semiconductor material and constitutes, for example, the semiconductor segment 22D of the TFT 22. The semiconductor film may include, for example, at least one of metal element species of In, Ga, and Zn and may be, for example, an In—Ga—Zn—O-based semiconductor (e.g., indium gallium zinc oxide). In the current context, the In—Ga—Zn—O-based semiconductor is a ternary oxide of In (indium), Ga (gallium), and Zn (zinc), is not limited in any particular manner in the ratio (composition ratio) of In, Ga, and Zn, and includes, for example, In:Ga:Zn=2:2:1, In:Ga:Zn=1:1:1, and In:Ga:Zn=1:1:2. The In—Ga—Zn—O-based semiconductor used in the semiconductor film may be either amorphous or crystalline. The semiconductor film may contain another oxide semiconductor in place of the In—Ga—Zn—O-based semiconductor. The semiconductor film may contain, for example, an In—Sn—Zn—O-based semiconductor (e.g., In₂O₃—SnO₂—ZnO; InSnZnO). The In—Sn—Zn—O-based semiconductor is a ternary oxide of In (indium), Sn (tin), and Zn (zinc). Alternatively, the oxide semiconductor layer may contain, for example, a W (tungsten)-containing In—W—Zn—O-based semiconductor, an In—W—Sn—Zn—O-based semiconductor, an In—Al—Zn—O-based semiconductor, an In—Al—Sn—Zn—O-based semiconductor, a Zn—O-based semiconductor, an In—Zn—O-based semiconductor, a Zn—Ti—O-based semiconductor, a Cd—Ge—O-based semiconductor, a Cd—Pb—O-based semiconductor, CdO (cadmium oxide), a Mg—Zn—O-based semiconductor, an In—Ga—Sn—O-based semiconductor, an In—Ga—O-based semiconductor, a Zr—In—Zn—O-based semiconductor, a Hf—In—Zn—O-based semiconductor, an Al—Ga—Zn—O-based semiconductor, a Ga—Zn—O-based semiconductor, or an In—Ga—Zn—Sn—O-based semiconductor. The oxide semiconductor material for the semiconductor film, when compared with a polysilicon semiconductor material, exhibits a high resistance under zero voltage (when turned off). In addition, the oxide semiconductor material for the semiconductor film, when compared with an amorphous silicon semiconductor material, exhibits a high electron mobility.

The gate insulation film 30, the first interlayer insulation film 31, and the second interlayer insulation film 33 are each made of an inorganic material such as silicon nitride (SiNₓ) or silicon oxide (SiO₂). The gate insulation film 30 keeps the first metal film on the lower layer side insulated from the semiconductor film and the second metal film on the upper layer side. The first interlayer insulation film 31, together with the planarization film 32 (detailed later), keeps the semiconductor film and the second metal film on the lower layer side insulated from the third metal film on the upper layer side. The second interlayer insulation film 33 keeps the third metal film insulated from the transparent electrode film. The planarization film 32 is made of an organic material such as PMMA (acrylic resin). The planarization film 32, made of organic material, has a larger thickness than any one of the gate insulation film 30, the first interlayer insulation film 31, and the second interlayer insulation film 33 all of which are made of an inorganic material. Specifically, the gate insulation film 30, the first interlayer insulation film 31, and the second interlayer insulation film 33 have a thickness of, for example, approximately from a few tens of nanometers to a few hundreds of nanometers, whereas the planarization film 32 has a thickness of, for example, approximately from 1 μm to 3 μm. The planarization film 32, together with the aforementioned first interlayer insulation film 31, keeps the semiconductor film and the second metal film on the lower layer side insulated from the third metal film on the upper layer side.

A description is given next of a cross-sectional structure of the TFT 22. Referring to FIG. 5, the gate electrode 22A of the TFT 22 is made of a part of the first metal film. The semiconductor segment 22D of the TFT 22 is made of a part of the semiconductor film and is disposed in an overlapping manner on the upper layer side of the gate electrode 22A via the gate insulation film 30. The source electrode 22B of the TFT 22 is made of a part of the second metal film and is in direct contact with one of the two end portions of the semiconductor segment 22D in terms of the X-axis direction from the upper layer side. The drain electrode 22C of the TFT 22 is made of a part of the second metal film and is in direct contact with the other end portion of the semiconductor segment 22D in terms of the X-axis direction from the upper layer side.

A description is given now of a cross-sectional structure of the pixel electrode 23. Referring to FIG. 5, the pixel electrode 23 includes: a first electrode segment (sixth electrode) 23A made of a part of the first metal film; a second electrode segment (second electrode) 23B made of a part of the third metal film; and a third electrode segment (third electrode) 23C made of a part of the transparent electrode film. Most of the first electrode segment 23A, the second electrode segment 23B, and the third electrode segment 23C are disposed overlapping each other.

Referring to FIGS. 4 and 5, the second electrode segment 23B is disposed partially overlapping almost all the end portion of the drain electrode 22C that is located opposite the source electrode 22B side. There is provided a first pixel contact hole (first contact hole) CHP1 opening at a location, in the first interlayer insulation film 31 and the planarization film 32 interposed between the second electrode segment 23B and the drain electrode 22C, that overlaps both the second electrode segment 23B and the drain electrode 22C. The second electrode segment 23B and the drain electrode 22C are connected together through the first pixel contact hole CHP1. Note that the structure of the second electrode segment 23B will be described later in detail.

Referring to FIGS. 4 and 5, the third electrode segment 23C is arranged to completely overlap the first electrode segment 23A, the second electrode segment 23B, and the TFT 22, to overlap parts of the two source lines 25 sandwiching the pixel electrode 23, and to not overlap the gate line 24, the capacitor branch line 26, and the gate connection line 27. More specifically, the third electrode segment 23C is provided from the gate line 24 all the way to the capacitor branch line 26 in terms of the Y-axis direction and is also provided all across the region sandwiched between the two gate connection lines 27 that are adjacent to the two source lines 25 sandwiching the pixel electrode 23 in terms of the X-axis direction. There is provided a second pixel contact hole (second contact hole) CHP2 opening at a location, in the second interlayer insulation film 33 interposed between the third electrode segment 23C and the second electrode segment 23B, that overlaps both the third electrode segment 23C and the second electrode segment 23B. The third electrode segment 23C and the second electrode segment 23B are connected together through the second pixel contact hole CHP2. This third electrode segment 23C is provided in the top layer of the array substrate 21 so as to reside closer to the opposite electrode 20A on the opposite substrate 20 than close to the first electrode segment 23A and the second electrode segment 23B. Therefore, when the pixel electrode 23 is charged, an electric field is generated between the third electrode segment 23C and the opposite electrode 20A, which are positioned opposite each other, so that an image can be displayed by the microcapsule layer MCR by utilizing the electric field.

Referring to FIGS. 4 and 5, the first electrode segment 23A is disposed partially overlapping a part of the end portion of the drain electrode 22C that is located opposite the source electrode 22B side. More specifically, the first electrode segment 23A is provided to spread less than the second electrode segment 23B in the Y-axis direction so as to not overlap the first pixel contact hole CHP1. There is provided a third pixel contact hole (fourth contact hole) CHP3 opening at a location, in the gate insulation film 30 interposed between the first electrode segment 23A and the drain electrode 22C, that overlaps both the first electrode segment 23A and the drain electrode 22C and that does not overlap the first pixel contact hole CHP1. The first electrode segment 23A and the drain electrode 22C are connected together through the third pixel contact hole CHP3. The first pixel contact hole CHP1 and the third pixel contact hole CHP3 are disposed side by side at a distance from each other in the Y-axis direction. More specifically, in the drain electrode 22C, the third pixel contact hole CHP3 is located farther from the semiconductor segment 22D than the first pixel contact hole CHP1 is located far from the semiconductor segment 22D.

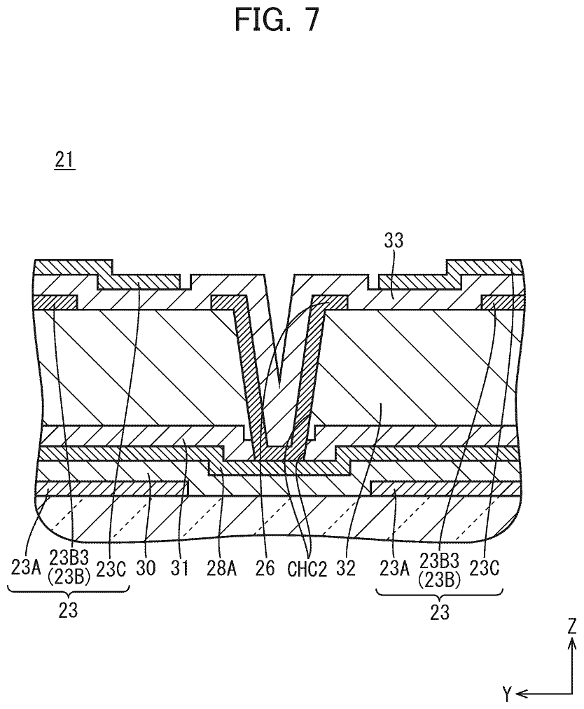

A description is now given of a cross-sectional structure of the capacitor electrode 28. Referring to FIGS. 4 and 7, the capacitor electrode main body 28A is made of a part of the second metal film. The capacitor electrode main body 28A is disposed overlapping the first electrode segment 23A via the gate insulation film 30 and overlapping the second electrode segment 23B via the first interlayer insulation film 31 and the planarization film 32. In other words, the capacitor electrode main body 28A is disposed being sandwiched between the first electrode segment 23A and the second electrode segment 23B in the Z-axis direction. Since an electrostatic capacity is formed between the capacitor electrode main body 28A and the first electrode segment 23A and between the capacitor electrode main body 28A and the second electrode segment 23B, the electrical potential of the charged pixel electrode 23 (the first electrode segment 23A, the second electrode segment 23B, and the third electrode segment 23C) can be retained in a satisfactory manner. Referring to FIGS. 4 to 6, the cover segment 28B of the capacitor electrode 28 is made of a part of the third metal film. The cover segment 28B is disposed overlapping the source electrode 22B, the drain electrode 22C, and the semiconductor segment 22D via the first interlayer insulation film 31 and the planarization film 32. The cover segment 28B can satisfactorily block the light that would otherwise enter the semiconductor segment 22D (in particular, the portion constituting a channel region). There is provided a first capacitor contact hole (third contact hole) CHC1 opening at a location, in the first interlayer insulation film 31 and the planarization film 32 interposed between the capacitor electrode main body 28A and the cover segment 28B, that overlaps both the capacitor electrode main body 28A and the cover segment 28B. The capacitor electrode main body 28A and the cover segment 28B are connected together through the first capacitor contact hole CHC1.

Referring to FIGS. 4 and 7, the capacitor branch line 26 is made of a part of the third metal film. In the display area AA, the capacitor branch line 26 extends in the X-axis direction and traverses the source line 25, the gate connection line 27, and the capacitor electrode main body 28A. More specifically, the capacitor branch line 26 crosses the source line 25, the gate connection line 27, and the capacitor electrode main body 28A via the first interlayer insulation film 31 and the planarization film 32 and crosses the gate connection line 27 via the gate insulation film 30. There is provided a second capacitor contact hole CHC2 opening at a location, in the first interlayer insulation film 31 and the planarization film 32 interposed between the capacitor branch line 26 and the capacitor electrode main body 28A, that overlaps both the capacitor branch line 26 and the capacitor electrode main body 28A. The capacitor branch line 26 is connected to the capacitor electrode main body 28A through the second capacitor contact hole CHC2. A plurality of second capacitor contact holes CHC2 are provided at intervals in the X-axis direction.

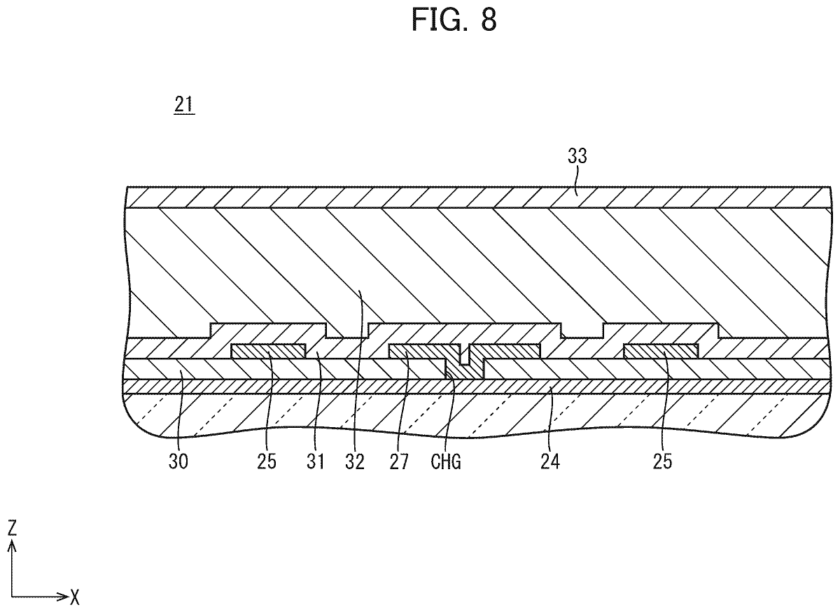

Referring to FIGS. 4 and 8, the gate connection line 27 extends almost all along the entire X-axis-wise length of the display area AA and crosses the source line 25 and the gate connection line 27 via the gate insulation film 30. There is provided a gate contact hole CHG opening at a location, in the gate insulation film 30, that overlaps both the gate connection line 27 and the gate line 24 which are to be connected together. The gate connection line 27 is connected to the gate line 24, which is to be connected, through the gate contact hole CHG. No gate contact hole CHG is provided at a location, in the gate insulation film 30, that overlaps both the gate connection line 27 and the gate line 24 which are not to be connected.

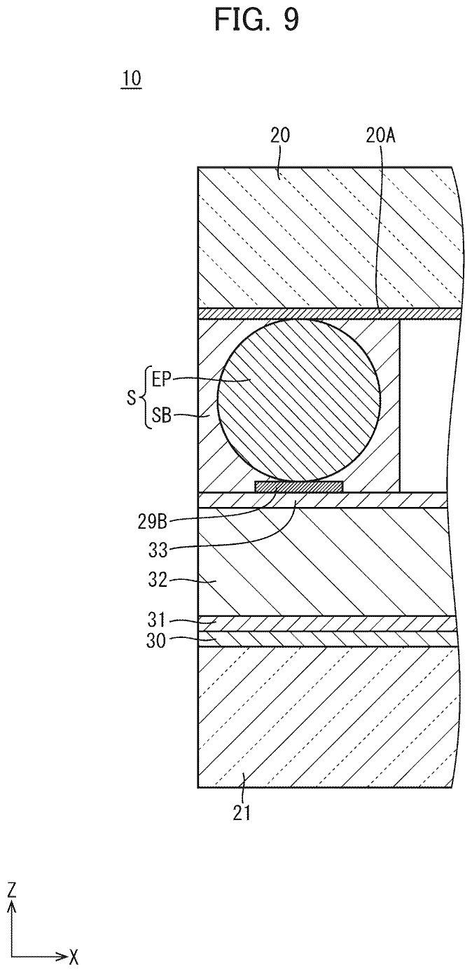

In addition, referring to FIG. 9, the sealing portion S includes: a seal base member SB made of, for example, a photosetting resin material or a thermosetting resin material; and numerous conductive particles (connecting portion) EP dispersed and blended in the seal base member SB. The conductive particles EP are prepared by, for example, performing conductive plating such as gold plating on the surface of synthetic resin particles. The particle size of the conductive particles EP is specified to be approximately equal to the distance between the opposite substrate 20 and the array substrate 21 (the thickness of the microcapsule layer MCR). The second main line structural component 29B of the capacitor main line 29 on the array substrate 21 and the opposite electrode 20A on the opposite substrate 20 are electrically connected through the conductive particles EP. The reference potential signal transferred by the capacitor main line 29 is configured to be supplied from the second main line structural component 29B to the opposite electrode 20A through the conductive particles EP.

Incidentally, referring to FIG. 5, a part of the third electrode segment 23C that is made of a part of the transparent electrode film on the array substrate 21 in accordance with the present embodiment is disposed overlapping a part, of the second electrode segment 23B that is made of a part of the third metal film, that does not overlap the drain electrode 22C. In other words, the third electrode segment 23C has at least: a portion that is a part overlapping the drain electrode 22C; and a portion that is a part not overlapping the drain electrode 22C, but overlapping the second electrode segment 23B. Note that the third electrode segment 23C has a portion overlapping neither the drain electrode 22C nor the second electrode segment 23B. In contrast, the capacitor electrode main body 28A made of a part of the second metal film is disposed overlapping a portion that does not overlap the drain electrode 22C made of a part of the second metal film and that does not overlap the drain electrode 22C of the second electrode segment 23B made of a part of the third metal film. In other words, the capacitor electrode main body 28A has at least a portion not overlapping the drain electrode 22C, but overlapping the second electrode segment 23B.

In this structure, referring to FIG. 5, the second electrode segment 23B includes a first overlapping portion 23B3 as a portion not overlapping the drain electrode 22C, but overlapping the third electrode segment 23C and overlapping the capacitor electrode main body 28A. In other words, the second electrode segment 23B is provided across the region overlapping both the third electrode segment 23C and the capacitor electrode main body 28A. The provision of the second electrode segment 23B across such a region enables increasing the freedom related to, for example, the arrangement and number of the site connected to the drain electrode 22C through the first pixel contact hole CHP1 and of the site connected to the third electrode segment 23C through the second pixel contact hole CHP2. Hence, the first pixel contact hole CHP1 and the second pixel contact hole CHP2 can be arranged not overlapping each other, and for this reason, the cross-sectional shape of the opening edge of the second pixel contact hole CHP2 in the second interlayer insulation film 33 is more likely to be appropriate. As a result, the second electrode segment 23B and the third electrode segment 23C, which are connected to each other, are less likely to develop a connection failure, which keeps the display quality of the electronic paper display device 10 in a satisfactory manner.

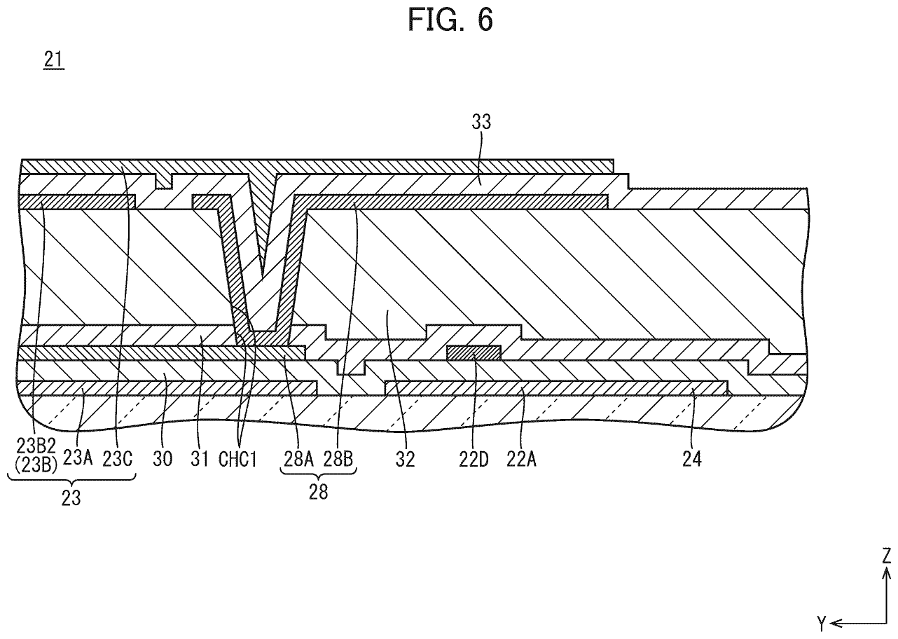

In the present embodiment, referring to FIGS. 4 and 6, the cover segment 28B covering the semiconductor segment 22D is connected to the capacitor electrode main body 28A through the first capacitor contact hole CHC1 in the first interlayer insulation film 31 and the planarization film 32. The provision of this cover segment 28B can render it difficult to provide, for example, the first pixel contact hole CHP1 and the second pixel contact hole CHP2 at a location overlapping the semiconductor segment 22D, but as described above, the provision of the second electrode segment 23B across the region overlapping both the third electrode segment 23C and the capacitor electrode main body 28A increases the freedom related to, for example, the foregoing arrangement and number in the first pixel contact hole CHP1 and the second pixel contact hole CHP2. Hence, the provision of the cover segment 28B is less likely to restrict, for example, the arrangement and number of the first pixel contact hole CHP1 and the second pixel contact hole CHP2.

Referring to FIG. 4, the capacitor electrode main body 28A extends in the X-axis direction from a location overlapping a part of the cover segment 28B all the way at least to a location that is separated by a distance in the Y-axis direction from the drain electrode 22C. Hence, the region for the provision of the capacitor electrode main body 28A can be sufficiently ensured while avoiding short-circuiting to the drain electrode 22C. Then, the second electrode segment 23B includes: a first extension 23B1 extending in the Y-axis direction from the location overlapping the drain electrode 22C (the first pixel contact hole CHP1) away from the drain electrode 22C; and a second extension 23B2 extending in the X-axis direction from the first extension 23B1 at least all the way to a location that is separated by a distance in the Y-axis direction from the cover segment 28B. Hence, the region for the provision of the second electrode segment 23B can be sufficiently ensured while avoiding short-circuiting to the cover segment 28B. The provision of the second electrode segment 23B and the capacitor electrode main body 28A, which overlap each other, in these regions enables further increasing freedom of, for example, the arrangement and number of the first pixel contact hole CHP1 and the second pixel contact hole CHP2. Besides, the first extension 23B1 overlaps a part of the capacitor electrode main body 28A. In other words, the first overlapping portion 23B3, of the second electrode segment 23B, that overlaps both the third electrode segment 23C and the capacitor electrode main body 28A resides in a part of the first extension 23B1 (the part overlapping the capacitor electrode main body 28A) and substantially all across the entire region of the second extension 23B2. The presence of the first overlapping portion 23B3 in such regions enables further increasing freedom of, for example, the arrangement and number of the first pixel contact hole CHP1 and the second pixel contact hole CHP2.

In addition, in the present embodiment, the transparent electrode film provided in the top layer of the array substrate 21 constitutes the third electrode segment 23C of the pixel electrode 23 and the second main line structural component 29B of the capacitor main line 29. The second main line structural component 29B is designated to supply the reference potential signal to the opposite electrode 20A through the conductive particles EP in the sealing portion S. Tentatively in comparison with when the second main line structural component 29B is made of a part of a metal film, the second main line structural component 29B is less likely to be corroded even if the second main line structural component 29B is exposed in the top layer of the array substrate 21. The third electrode segment 23C is for generating an electric field between the third electrode segment 23C and the opposite electrode 20A and is separated by a narrower gap (smaller distance) from the opposite electrode 20A than the second electrode segment 23B made of a part of the third metal film is separated from the opposite electrode 20A. Therefore, tentatively in comparison with when the third electrode segment 23C is omitted, the electric field strength related to the electric field generated between the pixel electrode 23 and the opposite electrode 20A can be further increased, and for this reason, excellent display quality can be achieved.

As described above, the array substrate 21 in accordance with the present embodiment includes: a drain electrode (first electrode) 22C including a part of a second metal film (first conductive film); a first interlayer insulation film 31 and a planarization film 32 that are a first insulation film disposed on an upper layer side of the second metal film; a second electrode segment (second electrode) 23B including a part of a third metal film (second conductive film) on an upper layer side of the planarization film 32 which is the first insulation film and partially overlapping the drain electrode 22C; a second interlayer insulation film (second insulation film) 33 disposed on an upper layer side of the third metal film; a third electrode segment (third electrode) 23C including a part of a transparent electrode film (third conductive film) on an upper layer side of the second interlayer insulation film 33 and partially overlapping a part of the second electrode segment 23B that does not overlap the drain electrode 22C; and a capacitor electrode main body (fourth electrode) 28A including a part of the second metal film and not overlapping the drain electrode 22C, but overlapping a part of the second electrode segment 23B that does not overlap the drain electrode 22C, wherein a first pixel contact hole (first contact hole) CHP1 that connects the drain electrode 22C and the second electrode segment 23B is provided at a location, in the first interlayer insulation film 31 and the planarization film 32 which are the first insulation film, that overlaps both the drain electrode 22C and the second electrode segment 23B, and a second pixel contact hole (second contact hole) CHP2 that connects the second electrode segment 23B and the third electrode segment 23C is provided at a location, in the second interlayer insulation film 33, that overlaps both the second electrode segment 23B and the third electrode segment 23C, but that does not overlap the first pixel contact hole CHP1.

The second electrode segment 23B is connected to the drain electrode 22C through the first pixel contact hole CHP1 in the first interlayer insulation film 31 and the planarization film 32 which are the first insulation film and connected also to the third electrode segment 23C through the second pixel contact hole CHP2 in the second interlayer insulation film 33. An electrostatic capacity is formed between the second electrode segment 23B and the capacitor electrode main body 28A which overlap each other via the first interlayer insulation film 31 and the planarization film 32 which are the first insulation film. The second electrode segment 23B has a portion not overlapping the drain electrode 22C, but overlapping the third electrode segment 23C this portion overlaps the capacitor electrode main body 28A. In other words, the provision of the second electrode segment 23B across the entire region that overlaps both the third electrode segment 23C and the capacitor electrode main body 28A increases freedom of, for example, the arrangement and number of the site connected to the drain electrode 22C through the first pixel contact hole CHP1 and of the site connected to the third electrode segment 23C through the second pixel contact hole CHP2. Hence, the first pixel contact hole CHP1 and the second pixel contact hole CHP2 can be arranged not overlapping each other, and for this reason, the cross-sectional shape of the opening edge of the second pixel contact hole CHP2 in the second interlayer insulation film 33 is more likely to be appropriate. As a result, the second electrode segment 23B and the third electrode segment 23C, which are connected to each other, are less likely to develop a connection failure.

In addition, the array substrate 21 further includes: a semiconductor segment 22D including a part of a semiconductor film on a lower layer side of the second metal film and connected to the drain electrode 22C; and a cover segment 28B including a part of the third metal film and covering the semiconductor segment 22D, wherein the third metal film contains a metal material, the cover segment 28B is disposed overlapping a part of the capacitor electrode main body 28A, and a first capacitor contact hole (third contact hole) CHC1 that connects the cover segment 28B and the capacitor electrode main body 28A is provided at a location, in the first interlayer insulation film 31 and the planarization film 32 which are the first insulation film, that overlaps both the cover segment 28B and the capacitor electrode main body 28A. The covering of the semiconductor segment 22D by the cover segment 28B including a part of the third metal film containing a metal material enables the cover segment 28B to block the light that would otherwise travel toward the semiconductor segment 22D. Hence, the properties of the semiconductor segment 22D are less likely to change under light. The provision of the cover segment 28B can render it difficult to provide, for example, the first pixel contact hole CHP1 and the second pixel contact hole CHP2 at a location overlapping the semiconductor segment 22D, but as described above, the provision of the second electrode segment 23B across the region overlapping both the third electrode segment 23C and the capacitor electrode main body 28A increases the freedom related to, for example, the foregoing arrangement and number in the first pixel contact hole CHP1 and the second pixel contact hole CHP2. Hence, the provision of the cover segment 28B is less likely to restrict, for example, the arrangement and number of the first pixel contact hole CHP1 and the second pixel contact hole CHP2.

In addition, the drain electrode 22C extends in a first direction from a location overlapping a part of the semiconductor segment 22D at least to a location overlapping a part of the second electrode segment 23B, the cover segment 28B extends in a second direction intersecting with the first direction from a location overlapping the semiconductor segment 22D to a location overlapping a part of the capacitor electrode main body 28A, the capacitor electrode main body 28A extends in the first direction from a location overlapping a part of the cover segment 28B at least to a location that is separated by a distance in the second direction from the drain electrode 22C, and the second electrode segment 23B includes: a first extension 23B1 extending in the second direction from a location overlapping the drain electrode 22C away from the drain electrode 22C; and a second extension 23B2 extending in the first direction from the first extension 23B1 at least to a location that is separated by a distance in the second direction from the cover segment 28B. The capacitor electrode main body 28A extends in the first direction from a location overlapping a part of the cover segment 28B to be connected all the way at least to a location that is separated by a distance in the second direction from the drain electrode 22C, and for this reason, the region for the provision of the capacitor electrode main body 28A can be sufficiently ensured while avoiding short-circuiting to the drain electrode 22C. The second electrode segment 23B includes: the first extension 23B1 extending in the second direction from a location overlapping the drain electrode 22C away from the drain electrode 22C; and the second extension 23B2 extending in the first direction from the first extension 23B1 at least to a location that is separated by a distance in the second direction from the cover segment 28B, and for this reason, the region for the provision of the second electrode segment 23B can be sufficiently ensured while avoiding short-circuiting to the cover segment 28B. The provision of the second electrode segment 23B and the capacitor electrode main body 28A, which overlap each other, in these regions enables further increasing freedom of, for example, the arrangement and number of the first pixel contact hole CHP1 and the second pixel contact hole CHP2.

In addition, the array substrate 21 further includes: a semiconductor segment 22D including a part of a semiconductor film on a lower layer side of the second metal film and connected to the drain electrode 22C; a gate insulation film (third insulation film) 30 disposed on a lower layer side of the semiconductor film; a gate electrode (fifth electrode) 22A including a part of a first metal film (fourth conductive film) on a lower layer side of the gate insulation film 30 and overlapping the semiconductor segment 22D; and a first electrode segment (sixth electrode) 23A including a part of the first metal film, wherein the first electrode segment 23A is disposed overlapping a part of the drain electrode 22C and further overlapping each of the second electrode segment 23B, the third electrode segment 23C, and the capacitor electrode main body 28A, and a third pixel contact hole (fourth contact hole) CHP3 that connects the drain electrode 22C and the first electrode segment 23A is provided at a location, in the gate insulation film 30, that overlaps both the drain electrode 22C and the first electrode segment 23A. When a signal is supplied to the gate electrode 22A, a channel region is generated in the semiconductor segment 22D, and a signal is supplied to the drain electrode 22C. Both the second electrode segment 23B and the first electrode segment 23A, which are connected to the drain electrode 22C, are charged to an electrical potential based on the signal supplied to the drain electrode 22C. An electrostatic capacity is formed between the second electrode segment 23B and the capacitor electrode main body 28A overlapping each other via the first interlayer insulation film 31 and the planarization film 32 which are the first insulation film, and additionally, an electrostatic capacity is formed between the capacitor electrode main body 28A and the first electrode segment 23A overlapping each other via the gate insulation film 30. Hence, the electrical potentials of the second electrode segment 23B and the first electrode segment 23A are maintained in a satisfactory manner.

The electronic paper display device (display device) 10 in accordance with the present embodiment includes: the array substrate 21 described above; an opposite substrate 20 disposed opposite the array substrate 21; and a microcapsule layer (display layer) MCR configured to display an image and disposed so as to be sandwiched between the array substrate 21 and the opposite substrate 20. This electronic paper display device 10 makes it less likely to develop a connection failure in the second electrode segment 23B and the third electrode segment 23C which are connected to each other, thereby keeping display quality in a satisfactory manner.

In addition, the electronic paper display device 10 further include: an opposite electrode (seventh electrode) 20A provided on the opposite substrate 20 opposite the third electrode segment 23C; a second main line structural component (a first wiring line) 29B including a part of the transparent electrode film and provided on the array substrate 21 opposite a part of the opposite electrode 20A; and conductive particles (a connecting portion) EP disposed so as to be sandwiched between the opposite substrate 20 and the array substrate 21 and connected to the opposite electrode 20A and the second main line structural component 29B. The signal transferred by the second main line structural component 29B is supplied to the opposite electrode 20A through the conductive particles EP. An electric field is generated between the third electrode segment 23C and the opposite electrode 20A, which are positioned opposite each other, so that an image can be displayed by the microcapsule layer MCR by utilizing the electric field. Since the third electrode segment 23C is made of a part of the transparent electrode film constituting the opposite electrode 20A, the distance between the third electrode segment 23C and the opposite electrode 20A can be reduced to a minimum. Hence, the electric field strength related to the electric field generated between the third electrode segment 23C and the opposite electrode 20A can be sufficiently high, and for this reason, excellent display quality can be achieved.

In addition, the third conductive film is a transparent electrode film containing a transparent electrode material. Tentatively, in comparison with when the third conductive film is made of a metal material, the second main line structural component 29B is less likely to be corroded even if the second main line structural component 29B is exposed on the surface of the array substrate 21.

In addition, the display layer is a microcapsule layer (electronic paper layer) MCR containing a plurality of microcapsules MC containing charged particles or a plurality of microcups containing charged particles, and the second electrode segment 23B and the third electrode segment 23C include a plurality of second electrode segments 23B and a plurality of third electrode segments 23C respectively so as to overlap each of the plurality of microcapsules MC or each of the plurality of microcups. The charged particles contained in the plurality of microcapsules MC or the plurality of microcups can be caused to flow in accordance with the voltage applied to the plurality of second electrode segments 23B and the plurality of third electrode segments 23C. Hence, a prescribed image is display on the microcapsule layer MCR.

### Other Embodiments

The techniques disclosed in the present specification are not necessarily limited to the embodiments discussed in the foregoing description with reference to drawings, and as an example, the following embodiments are also encompassed in the technical scope of the present disclosure.
(1) A metal film may be used in place of the transparent electrode film positioned in the top layer of the array substrate 21.
(2) The gate line 24 may be provided for each row of a plurality of pixel electrodes 23 arranged next to each other in the X-axis direction. When this is the case, the number of the gate lines 24 provided is equal to the number of the rows of pixel electrodes 23. Together with this, the source line 25 may be provided for each column of a plurality of pixel electrodes 23 arranged next to each other in the Y-axis direction, so that the number of the source lines 25 provided can be equal to the number of the columns of pixel electrodes 23. Note that it follows that the capacitor branch line 26 is disposed overlapping a prescribed gate line 24. In addition, the number of the gate connection lines 27 provided may be altered in accordance with the number of the gate lines 24 provided.
(3) An inspection line for inspecting, for example, the gate lines 24 for the presence/absence of a break therein may be provided on the array substrate 21. The inspection line is disposed in the non-display area NAA and connected to an end portion of the gate line 24.
(4) The array substrate 21 may include: a source driver for supplying an image signal to the source lines 25; and a gate driver for supplying a scan signal to the gate connection lines 27.
(5) The gate connection lines 27 running vertically across the display area AA may be omitted, and a gate drive circuit connected to end portions of the gate lines 24 may be provided in the non-display area NAA. The gate drive circuit supplies a scan signal directly to the gate lines 24. Note that a gate driver may be used instead of the gate drive circuit.
(6) The semiconductor film constituting the semiconductor segment 22D may be made of, for example, a polysilicon (LTPS) or an amorphous silicon.
(7) In the opposite substrate 20 and the array substrate 21, a glass substrate made of glass may be used in place of the resin substrate.
(8) The driver 11 may be mounted to the flexible substrate 12 by COF (chip on film).
(9) The electronic paper display device 10 may have a plan-view shape such as a vertically elongated rectangle, a square, a circle, a semicircle, a vertically elongated circle, an ellipse, or a trapezoid.
(10) The electronic paper display device 10 may operate by using microcup electrophoretic technology. The electronic paper display device 10 that operates by microcup electrophoretic technology includes an electronic paper layer structured as below. The electronic paper layer includes: a microcup-containing substrate; a sealing portion attached to the substrate so as to seal the microcups; and an opposite electrode stacked on the front side of the substrate. The substrate is made of a transparent synthetic resin material and has microcups that are open toward the back side. More specifically, the substrate has a partition wall that is shaped like a lattice in a plan view, and each space partitioned by this partition wall provides a microcup. A plurality of microcups are provided in a matrix in the primary face of substrate in a plan view. The plurality of microcups are disposed overlapping the pixel electrodes 23 on the array substrate 21. The microcups contain both positively charged particles and negatively charged particles as well as an insulation fluid made of a silicone oil. The electronic paper display device 10 structured in this manner can deliver the same functions and effects as Embodiment 1 described above.
(11) The operating method of the electronic paper display device 10 may be changed to, for example, an electronic liquid powder method, an electrowetting method, or a cholesteric liquid crystal method, other than (10) described above, where appropriate.
(12) The electronic paper display device 10 may be replaced by another display device (e.g., a liquid crystal panel or an organic EL display panel).

What is claimed is:

1. An array substrate comprising:
a first electrode including a part of a first conductive film;
a first insulation film disposed on an upper layer side of the first conductive film;
a second electrode including a part of a second conductive film on an upper layer side of the first insulation film and partially overlapping the first electrode;
a second insulation film disposed on an upper layer side of the second conductive film;
a third electrode including a part of a third conductive film on an upper layer side of the second insulation film and partially overlapping a part of the second electrode that does not overlap the first electrode; and
a fourth electrode including a part of the first conductive film and not overlapping the first electrode, but overlapping a part of the second electrode that does not overlap the first electrode, wherein
a first contact hole that connects the first electrode and the second electrode is provided at a location, in the first insulation film, that overlaps both the first electrode and the second electrode, and
a second contact hole that connects the second electrode and the third electrode is provided at a location, in the second insulation film, that overlaps both the second electrode and the third electrode, but that does not overlap the first contact hole.

2. The array substrate according to claim 1, further comprising:
a semiconductor segment including a part of a semiconductor film on a lower layer side of the first conductive film and connected to the first electrode; and
a cover segment including a part of the second conductive film and covering the semiconductor segment, wherein
the second conductive film contains a metal material,
the cover segment is disposed overlapping a part of the fourth electrode, and
a third contact hole that connects the cover segment and the fourth electrode is provided at a location, in the first insulation film, that overlaps both the cover segment and the fourth electrode.

3. The array substrate according to claim 2, wherein
the first electrode extends in a first direction from a location overlapping a part of the semiconductor segment at least to a location overlapping a part of the second electrode,
the cover segment extends in a second direction intersecting with the first direction from a location overlapping the semiconductor segment to a location overlapping a part of the fourth electrode,
the fourth electrode extends in the first direction from a location overlapping a part of the cover segment at least to a location that is separated by a distance in the second direction from the first electrode, and
the second electrode includes:
a first extension extending in the second direction from a location overlapping the first electrode away from the first electrode; and
a second extension extending in the first direction from the first extension at least to a location that is separated by a distance in the second direction from the cover segment.

4. The array substrate according to claim 1, further comprising:
a semiconductor segment including a part of a semiconductor film on a lower layer side of the first conductive film and connected to the first electrode;
a third insulation film disposed on a lower layer side of the semiconductor film;
a fifth electrode including a part of a fourth conductive film on a lower layer side of the third insulation film and overlapping the semiconductor segment; and
a sixth electrode including a part of the fourth conductive film, wherein
the sixth electrode is disposed overlapping a part of the first electrode and further overlapping each of the second electrode, the third electrode, and the fourth electrode, and
a fourth contact hole that connects the first electrode and the sixth electrode is provided at a location, in the third insulation film, that overlaps both the first electrode and the sixth electrode.

5. A display device comprising:
the array substrate according to claim 1;
an opposite substrate disposed opposite the array substrate; and
a display layer configured to display an image and disposed so as to be sandwiched between the array substrate and the opposite substrate.

6. The display device according to claim 5, further comprising:
a seventh electrode provided on the opposite substrate opposite the third electrode;
a first wiring line including a part of the third conductive film and provided on the array substrate opposite a part of the seventh electrode; and
a connecting portion disposed so as to be sandwiched between the opposite substrate and the array substrate and connected to the seventh electrode and the first wiring line.

7. The display device according to claim 6, wherein the third conductive film is a transparent electrode film containing a transparent electrode material.

8. The display device according to claim 5, wherein
the display layer is an electronic paper layer containing a plurality of microcapsules containing charged particles or a plurality of microcups containing charged particles, and
the second electrode and the third electrode comprise a plurality of second electrodes and a plurality of third electrodes respectively so as to overlap the plurality of microcapsules or the plurality of microcups.
